(19) United States
(12) Patent Application Publication
(10) Pub. No.: US 2008/0138669 A1
(43) Pub. Date: Jun. 12, 2008

(54) Sulphur-Tolerant Anode For Solid Oxide Fuel Cell

(75) Inventors: David J. Bayless, Athens, OH (US); Jason P. Trembly, Morgantown, WV (US)

Correspondence Address: KREMBLAS, FOSTER, PHILLIPS & POLLICK, 7632 SLATE RIDGE BOULEVARD, REYNOLDSBURG, OH, 43068, US

(73) Assignee: OHIO UNIVERSITY, Athens, OH (US)

(21) Appl. No.: 11/908,852

(22) PCT Filed: Mar. 23, 2006
(86) PCT No.: PCT/US06/10620

§ 371 Date: Sep. 17, 2007

Related U.S. Application Data
(60) Provisional application No. 60/664,735, filed on Mar. 24, 2005.

(51) Int. Cl. H01M 4/00

(52) U.S. Cl. 429/12

(57) ABSTRACT

An anode for a solid oxide fuel cell. The anode is not harmed by sulfur-containing compounds, nor is its resistance increased thereby. The anode has two layers, including a “protective” layer (A) and a layer (B) that oxidizes molecular hydrogen The protective layer has a diffusion rate for molecular hydrogen that exceeds its diffusion rate for sulfur-containing compounds, and has an oxidation rate for sulfur-containing compounds that exceeds its oxidation rate for molecular hydrogen. The first anode layer can be selected fro the group of Lanthanum Strontium Titanate (LST) and Lanthanum Strontium Vanadate (LSV), and the second anode layer is made of Gadolinium Doped Cerium oxide (GDC) and nickel. The first layer can include Yttria Stabilized Ziroonia (YSZ), and the second layer can include YSZ interspersed throughout the layer as a separate phase.

### BACKGROUND OF THE INVENTION

This invention relates generally to fuel cell electrodes, and more particularly to an anode for a solid oxide fuel cell.

### DESCRIPTION OF THE RELATED ART

A planar solid oxide fuel cell (PSOFC) contains two planar electrodes that sandwich a planar electrolyte and typically operate in a temperature range of 600° C. to 1000° C. (see FIG. 2). The anode is typically made of a nickel (Ni)/yttria stabilized zirconia (YSZ) cermet, the cathode is typically made of a strontium doped lanthanum manganite (LSM), and the electrolyte is made of a 3 or 8 mol % YSZ. The PSOFC converts chemical energy into electrical energy through the following two reactions shown in Equations 1 and 2.

H₂+0.5O₂→H₂O (1)

CO+0.5O₂→CO₂ (2)

The fuel gas which may contain H₂, CO, or a combination of the two, is provided to the anode of the PSOFC and oxygen in the form of air is provided to the cathode side of the PSOFC. The H₂ and CO that enter the anode are then electrochemically oxidized. The electrochemical oxidation of each H₂ and CO molecule produces two electrons that travel to the cathode of the PSOFC through an external circuit, as shown in equations 3 and 4.

H₂+O²⁻→H₂O+2e⁻ (3)

CO+O²⁻→CO₂+2e⁻ (4)

The oxygen in the form of air is electrochemically reduced (shown in Equation 5) at the cathode by the electrons flowing from the external circuit coming from the anode, thus completing the circuit.

0.5O₂+2e⁻→O²⁻ (5)

The oxygen ions are transported through the ceramic electrolyte to the surface of the anode where they oxidize the H₂ and CO as shown in Equations 3 and 4.

A PSOFC thus directly converts chemical energy into electrical energy much like a battery. PSOFCs also produce heat and electricity, so they are potentially well-suited for distributed generation and combined heat and power.

PSOFCs also are capable of converting the energy of CO to electricity, just as PSOFCs can convert hydrogen H₂ to electricity. However, fuel cells used for automotive transport, such as Polymer Electrolyte Membrane (PEM; also called Proton Exchange Membrane) cells, only use H₂, because CO is not compatible with PEM cells. If fuel cells are to be used in cars, a reliable supply of H₂ is necessary.

Coal can be reformed into a synthetic gaseous fuel (“syngas”) containing CO and H₂ through a gasification process. This fuel can be used by a PSOFC to produce power and heat. Although CO has been found not to be as promising a PSOFC fuel as H₂, reformed hydrocarbons such as coal can be used as a practical fuel source. The use of coal, especially coal gasification, with fuel cells, could remedy many of the current pollution problems associated with traditional coal combustion processes and provide a reliable source of electricity, heat and hydrogen. Among the problems that fuel cells could help with include increasing efficiency of converting the energy of coal into electricity (from 32-34% by combustion to over 50% by fuel cell) and reducing emissions of pollutants (including nitrous oxides (NO_{X}), sulfur dioxides (SO_{X})), carbon dioxide (CO₂) and particulate matter. NO_{X} is known to be a precursor to the production of ground level ozone, NO_{X} and SO_{X} are precursors to the production of acid rain, and particulate matter that is emitted and formed in the atmosphere by NO_{X} and SO_{X} in the form of fine sulfate and nitrate particles is a precursor to respiratory problems in humans. PSOFCs in particular, and solid oxide fuel cells (SOFCs) in general, show great potential as a replacement for electricity produced by the combustion of coal.

Coal is an abundant fossil fuel and many countries have coal reserves spread out within their borders, allowing feasible transportation of coal to various destinations. Coal is also the lowest cost fossil fuel per unit of energy in many parts of the world. For example, in the United States coal has averaged approximately $1.34/MBtu in the recent past, compared to natural gas at $6.37/MBtu and heating oil at $5.11/MBtu. Because of these reasons, coal is used for more than 50 percent of the electrical energy production in the United States. The electric power production industry reported that electric production through the burning of coal used 1003.9 million short tons of coal in 2003. Because of coal's availability and price it is also very likely that coal will be the power production fuel of choice for years to come.

Because a PSOFC is capable of using CO, the H₂ produced during coal gasification could be used for automotive fuel cells, creating combined heat, power and H₂ as illustrated in FIG. 1. Widespread use of PSOFCs could change the energy paradigm, making distributed power a reality at efficiencies twice that of current power plants. Additionally, this could facilitate the distribution of H₂ generation, because PSOFCs can use CO that otherwise is incompatible with fuel cells being developed for automobiles. Thus, if PSOFCs can be used with coal-derived syngas, the H₂ in the gas could be separated for use with automotive (PEM) fuel cells, thereby providing a key source of distributed H₂ for the eventual H₂ economy.

Currently, PSOFCs for stationary power generation are being designed to use H₂, but the only method that is currently used to produce large amounts of H₂ for such PSOFCs is the reformation of natural gas. Natural gas has, in the recent past, had a cost as high as $14/MBtu. Coal is much more economical.

One substantial problem limiting the use of coal with PSOFCs is the sulfur in coal. Sulfur contained in coal is converted to the PSOFC contaminant hydrogen sulfide (H₂S) during the gasification process. H₂S degrades the performance of the anode of the PSOFC beyond acceptable limits. The degradation of the PSOFC takes place when the sulfur in the H₂S reacts with the nickel in the PSOFC anode to form nickel sulfide (Ni₂S₃). At concentrations greater than 1000 ppm this degrades the PSOFC, and it blocks reaction sites at lower concentrations. The increase in resistance can be very significant. For example, as little as 0.5 ppm of H₂S can cause potential losses that drastically reduce power production by the PSOFC until failure. As the concentration of H₂S in the fuel gas increases, there is an increase in the amount of sulfur present at the anode of the PSOFC. The reduction in power production occurs due to reduction in the amount of available reaction sites for the oxidation of H₂. H₂S concentrations in syngas can reach as high as 0.95 volume percent. Although the H₂S concentration in coal syngas may be reduced to approximately 200-300 ppm with the addition of solid adsorbents into the gasification column, this range will still cause damage to the PSOFC.

Conventional PSOFCs typically have an anode made of a cermet mixture of 50 volume percent nickel (Ni) and balance 8 mol % yttria stabilized zirconia (YSZ). These anodes show very little tolerance to sulfur species that are present in reformed hydrocarbon fuels such as gasified coal which may contain 200 to 5000 ppm H₂S. Since the sulfur content of oxygen-blown gasified coal may only be reduced to a range of 200 to 300 ppm H₂S with the use of solid adsorbents, Ni/YSZ cermet anodes cannot be used for the PSOFCs in a distributed power generation source using gasified coal as the fuel source.

Research has shown varying amounts of resistance to sulfur contamination based on the SOFC configuration and anode material. For example, a simulated coal-derived fuel gas containing 1 ppm of H₂S caused the open cell potential in a tubular SOFC operating at 1000° C. to decrease after 24 hours of operation (Maskalisk and Ray, 1992) while others found that an anode made of zirconium oxide and nickel could be artificially poisoned by H₂S (Geyer, 1996).

SOFC's have a higher H₂S tolerance as the operation temperature is increased. Research revealed that a PSOFC began to experience potential losses at H₂S concentrations of 0.05, 0.5, and 2 ppm at temperatures of 1023K, 1173K, and 1273K respectively (Matsuzaki and Yasuda, 2000). Although it would seem logical to increase the temperature of the PSOFC to increase the sulfur tolerance of the device, this does not follow, because the operational temperature of the PSOFC is kept low to increase operational efficiency of the fuel cell. Lower cost metal interconnects may be used in a low temperature PSOFC stack. Higher temperatures require the use of ceramic interconnects, which are a magnitude higher in cost than their metallic counterparts.

Sulfur tolerant anodes have been developed by replacing the YSZ of the anode cermet with gadolinium doped cerium oxide (GDC). The addition of GDC to the anode of the PSOFC expands the triple phase boundary (TPB) of the PSOFC, which is the area where all three reactants and products (H₂, CO, O²⁻, and e⁻) are found. Because of GDC's ability to conduct both O²⁻ and e⁻ the material is classified as a mixed ionic and electronic conductor (MIEC). GDC allows for electrons produced from the oxidation of the reactant gases to flow through it (as compared to YSZ which will only conduct O²⁻) allowing alternative flow paths for the electrons other than nickel. The addition of GDC does not stop the formation of Ni₂S₃ or blocking of reaction sites at the anode of the PSOFC in the presence of H₂S, but allows for the conduction of electrons produced by the oxidation reactions to go through it rather than not being able to flow at all if the reactive nickel site is surrounded by Ni₂S₃ formations. Research has been conducted at the Ohio Coal Research Center of Ohio University investigating the ability of PSOFC anodes containing GDC to be used in a distributed power generation system using Ohio gasified coal as its fuel source. FIG. 3 presents data from completed research at the Ohio Coal Research Center using PSOFCs containing GDC and operating on H₂/N₂ anode fuel gas, a simulated coal syngas containing 40.0 mol % CO and 26.3 mol % H₂, and balance N₂, and the same simulated coal syngas containing 250 ppm H₂S.

From the data shown in FIG. 3, the PSOFCs showed good performance using the simulated coal syngas without H₂S contaminant, and this simulated syngas is comparable to the H₂/N₂ fuel gas. However, with the addition of 250 ppm H₂S into the simulated coal syngas composition, the resistance of the PSOFC increased. An overall increase in the resistance of the PSOFC of approximately 37.4±3.3% was observed. Although this performance is much better than Ni/YSZ cermet anodes, which resulted in an instantaneous increase of 200 percent in the PSOFC resistance with a fuel gas containing only 5 ppm H₂S, the overall degradation in the performance of the PSOFC is still too high to be used in a distributed power generation system using gasified coal. The distributed power generation system being developed at Ohio University is expected to need a PSOFC anode that will be capable of utilizing oxygen blown gasified coal with 200 to 300 ppm H₂S while only experiencing an increase in the PSOFC resistance of 5 percent or less.

Other research has investigated the effect of replacing the cermet of the PSOFCs with a sulfur-resistant perovskite material. It was theorized that by using a material that is inherently sulfur resistant as an anode a PSOFC may be operated using a fuel gas containing sulfur contaminants while experiencing little to no degradation in performance. Some of the perovskite materials that have been used are La_{0.7}Sr_{0.3}VO₃ and Sr_{0.6}La_{0.4}TiO₃. Although these materials have shown good resistance to sulfur species in the fuel gas and also have the ability to electrochemically oxidize H₂S, their performance is not as good as the Ni/YSZ and Ni/GDC anode materials utilizing sulfur-free fuels. The current densities of the sulfur tolerant materials is much lower than the cermet materials discussed above, thereby causing lower power production per unit area of anode.

### BRIEF SUMMARY OF THE INVENTION

The invention is an improved anode in a solid oxide fuel cell having an electrolyte. The improved anode is positioned in a fluid flow path through which a fluid flows that contains molecular hydrogen and at least one sulfur-containing compound. The anode comprises two layers. A first anode layer has an outer surface in the fluid flow path, and is made of a material having a diffusion rate for molecular hydrogen that exceeds a diffusion rate for sulfur-containing compounds. This is due to the size difference between the molecules and the concentration differential in the anode near the fluid flow path and near the electrolyte. The first anode layer material also has an oxidation rate for sulfur-containing compounds that exceeds an oxidation rate for molecular hydrogen. In fact, it is contemplated to use a material for the first layer that does not oxidize molecular hydrogen. The second anode layer is interposed between the first anode layer and the electrolyte. The second anode layer is made of a material which oxidizes molecular hydrogen, carbon monoxide or both.

In a preferred embodiment of the invention, the first anode layer is either Lanthanum Strontium Titinate or Lanthanum Strontium Vanadate. The second anode layer is preferably made of Gadalonium Doped Cerium oxide and nickel.

In one embodiment, the first layer includes Yttria Stabilized Zirconia, and the second layer has Yttria Stabilized Zirconia interspersed throughout the layer as a separate phase. In this embodiment, the second layer includes Lanthanum Strontium Vanadate powder interspersed in the second layer at the interface with the electrolyte. The powder can constitute about 3.0 weight percent of the second layer, and oxidizes any sulfur-containing compound that is not oxidized prior to diffusing to this layer. The powder can, or course, constitute more or less than 3.0 weight percent of the second layer.

It is contemplated that the first anode layer is between about 5 microns and about 30 microns thick, and the porosity of the first anode layer is less than about forty percent.

The invention is a multiple-layer, preferably a two-layer, anode that produces a high current density, and sustains power generation for long periods of time (>10,000 hrs) using gasified coal containing H₂S as a fuel. The anode uses multiple anode layers specifically formulated to produce sulfur tolerance and efficiently oxidize hydrogen with a resistance comparable to current PSOFC anodes.

The preferred embodiment has two reaction zones in the anode that are formed in layers. The first reaction zone, located in the outer layer, allows for a slower diffusion of H₂S into the anode than for molecular hydrogen, and has a higher oxidation rate of H₂S during its diffusion than for molecular hydrogen. This layer is made of a material that is highly active toward the oxidation of H₂S and has a morphology (e.g., pore size) within a preferred range. The second reaction zone, located in the inner layer of the PSOFC, allows rapid and efficient oxidation of hydrogen with a low resistance that will allow for a high current density with low overpotential.

The invention can be described more broadly than with simply the materials and their relative constituents discussed above, which are not the only materials that could be used with the invention, nor the only relative quantities. It is contemplated that any material meeting the requirements described herein could be substituted for the materials discussed herein, as will become apparent to a person having ordinary skill in the art. The anode has multiple layers, and, in particular, a protective top layer that oxidizes H₂S before it comes into contact with the nickel of the H₂ oxidation layer.

The invention thus comprises the addition of a “protective” layer of sulfur-tolerant material on a Ni/GDC layer. The combination of these two layers prevents the H₂S from attacking the inner anode layer formulated for H₂ oxidation by causing H₂S to slowly diffuse, and by oxidizing the H₂S during that diffusion. The sulfur tolerant layer of the PSOFC acts as a selective membrane that allows more rapid diffusion of H₂ through its structure than H₂S to allow the H₂S to be electrochemically oxidized by the protective layer during the slow diffusion.

### BRIEF DESCRIPTION OF THE SEVERAL VIEWS OF THE DRAWINGS

FIG. 1 is a schematic illustration of a conventional heat, power and hydrogen generating apparatus using a solid oxide fuel cell.

FIG. 2 is a schematic illustration of a conventional planar solid oxide fuel cell.

FIG. 3 is a table showing results of the resistance in a PSOFC over time for variations in fuel gas compositions.

FIG. 4 is a schematic side view of an experimental PSOFC button.

FIG. 5 is a schematic side view of a PSOFC incorporating the present invention.

FIG. 6 is a schematic side view of another PSOFC incorporating the present invention.

FIG. 7 is a VI (voltage-current) scan and power plot for a cell that is conventional and a cell with a protective layer formed on the anode according to the invention.

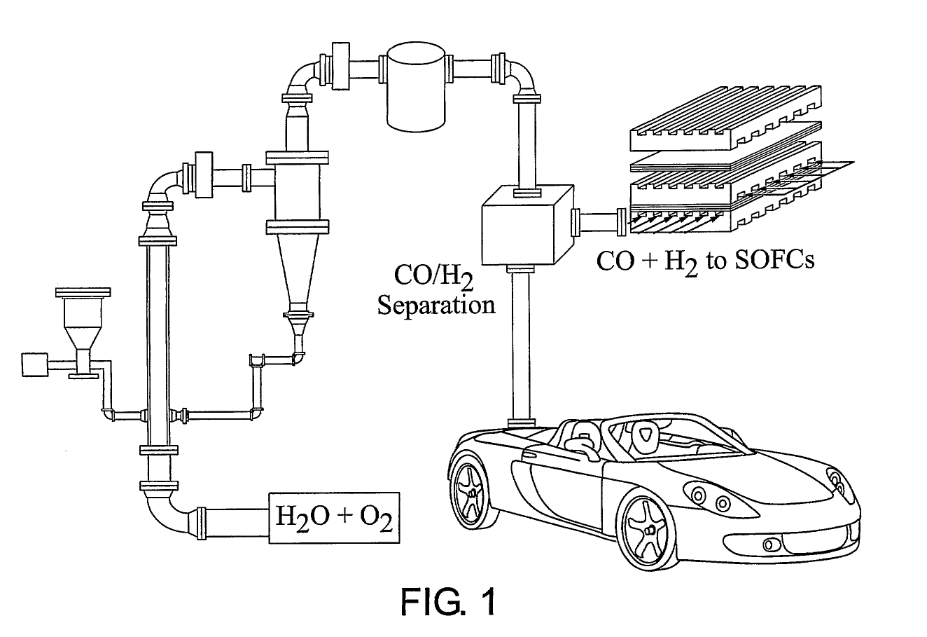

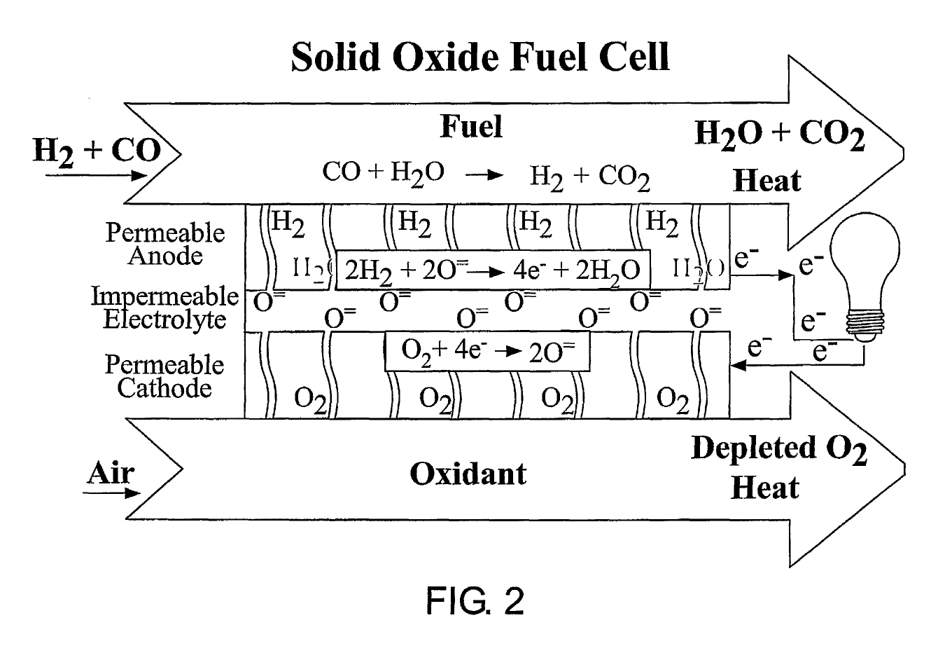

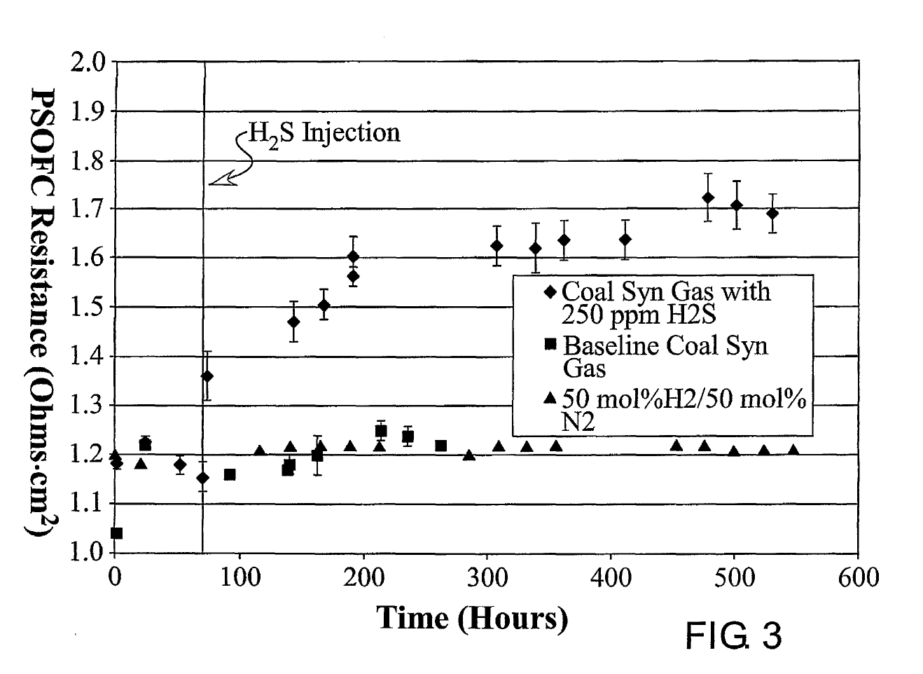

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

A schematic illustration of one embodiment of the invention is shown in FIG. 5. FIG. 5 shows a three-layer PSOFC anode where A is the sulfur-tolerant layer, B is the optimized H₂ oxidation layer, C is a thin layer of Yttria Stabilized Zirconia that promotes ionic conduction, D is a reference electrode, and E is the electrolyte. The electrolytes of the PSOFCs used in the research can be made of scandia stabilized zirconia (SSZ) or YSZ.

In FIG. 6, a two layer preferred embodiment is shown in which A is the sulfur-tolerant layer, B is the optimized H₂ oxidation layer, D is a reference electrode, and E is the electrolyte. The outer layer A is exposed to a flow of a fluid, which can be a liquid or a gas, such as a stream of gasified coal (syngas) containing a sulfur compound, such as H₂S. The inner layer B preferably is not exposed directly to the fluid flow path, but all chemicals in the fluid preferably have to diffuse through the layer A to come into contact with the layer B.

The outer, sulfur-tolerant layer A is preferably Lanthanum Strontium Titinate or Lanthanum Strontium Vanadate. Additionally, the layer A can contain some Yttria Stabilized Zirconia, for example, in a range between about 10 and about 25 weight percent.

The inner layer B is preferably made of Gadalonium Doped Cerium oxide and nickel. It is contemplated to intersperse particulate made of Yttria Stabilized Zirconia throughout the layer B as a separate phase to promote ionic conduction. Yttria Stabilized Zirconia may not be added since Gadalonium Doped Cerium oxide has a higher ionic conductivity than Yttria Stabilized Zirconia. However, if this particulate is added to layer B, it is contemplated to add it in a range between about 10 and about 25 weight percent

In a most preferred embodiment, a small amount of a very high surface area powder Lanthanum Strontium Vanadate is interspersed in the inner layer B at the interface with the electrolyte. This powder constitutes about 3.0 weight percent of the inner layer B in one embodiment, but could be more or less, and this amount allows direct electrochemical oxidation of the H₂S contaminants while H₂ may still be electrochemically oxidized on the Ni sites.

The invention is a high performance, sulfur-tolerant PSOFC that addresses many of the problems of the prior art anodes, and may be used in a distributed power generation system using hydrocarbon fuels containing H₂S.

The relative oxidation rates of H₂ and CO at the PSOFC anode are an important factor in the invention. Research showed that H₂ is more readily oxidized at the anode of the PSOFC because the H₂ molecules diffuse much faster than the CO molecules due to the latter's much larger size. However CO still may serve as a fuel for the PSOFC in a mixture of H₂ and CO due to the water-gas shift shown in Equation 6.

CO+H₂O→H₂+CO₂ (6)

Test results have shown that coal syngas can be used as a fuel in the invention with little to no apparent degradation in the performance of the PSOFC. For example, Applicants operated the PSOFCs under a constant current, and measured the voltage losses of the PSOFC anode by using a four electrode arrangement with AC impedance spectroscopy. This gave the optimal thickness and components of the anode by maximizing the current density of the PSOFC while minimizing the power losses in the anode of the PSOFC. The performance of the baseline anode composition and stricture of the PSOFC were measured utilizing a coal syngas that contained a mixture of H₂, H₂O, CO, CO₂, and N₂. The preferred thickness of the outer layer is preferably in the range of about 5 and about 30 microns. A thickness above about 30 microns seemed to increase the resistance too significantly.

Applicants also operated the PSOFC utilizing the same coal syngas mixture with H₂S concentrations in the range of 200 to 1000 ppm. The sulfur tolerance of the baseline anode was determined so that the effect of the sulfur tolerant layer could be determined.

Applicants constructed a PSOFC stack, PSOFC single cell, and two PSOFC button cell testing systems that were used to test PSOFCs with simulated coal syngas as the anode fuel. The single cell test stand is capable of testing PSOFCs with an electrode area of 70 cm². The PSOFC stack test stand is capable of testing a fuel cell stack containing up to five PSOFCs with an electrode area of 125 cm² and the two PSOFC button cell test stands are capable of testing PSOFCs with an electrode area of 4 cm². All of the gas delivery systems used in the testing are capable of producing simulated coal syngases containing varying concentrations of H₂, CO, CO₂, N₂, H₂O, H₂S, and Hg, as well as oxygen enriched cathode air.

Screen printing or tape casting can be used for production of the new anode. This is important for two reasons: (1) using these methods allows for thin layers of material to be produced, reducing the overall material costs of the cells; and (2) these production methods are conventionally used in the fuel cell industry. The invention thus requires little capital investment or additional equipment for current fuel cell producers and adds little materials costs to the PSOFC anode itself.

Tape casting and screen printing machines were used for the production of PSOFC button cells and larger single cell configurations. The tape casting machine is capable of producing tape casts with thicknesses as small as 100 μm that can be used for the production of electrolyte and anode supported PSOFCs. The screen printing machine is capable of producing ceramic layers as thin as 10 μm and can be used to produce the multi-layer sulfur tolerant anodes.

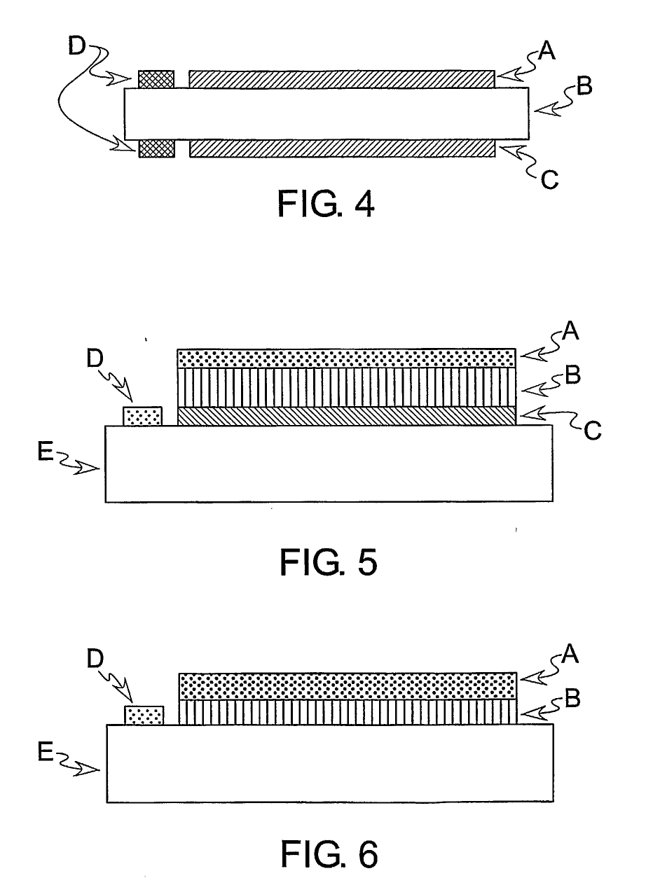

In order to produce a PSOFC anode that was capable of utilizing gasified coal with high levels of H₂S (greater than 300 ppm) a four electrode button cell configuration was made (see FIG. 4). In FIG. 4, A is the anode, B is the electrolyte, C is the cathode, and D are the reference electrodes. The PSOFC button cells have an approximate diameter of 2.54 cm and a thickness of 500 μm and a cathode diameter of 1.59 cm² and a thickness of 50 μm. Although typical commercial electrolyte supported PSOFCs have a thickness of 200 μm, it was thought that the extra thickness in the PSOFC electrolyte would prevent cracking during warm-up and separate the electrochemical mechanisms that take place at the anode and cathode of the PSOFC. Thus, the tests used reliable predictors of how the PSOFCs will perform in service.

PSOFC anode sulfur tolerance was determined via electrochemical impedance spectroscopy (EIS) using a Solartron brand potentiostat and impedance analyzer. The PSOFC button cell test configuration described above was used to determine the ohmic resistance of the anode, the charge transfer resistance of the anode and the double layer capacitance of the anode. The performance over time was monitored while utilizing simulated coal syngas with varying concentrations of H₂S.

Also, material analyses were completed on the PSOFC anodes before and after testing to determine the effect that the simulated coal syngas had on the composition and structure of the anode. Scanning electron microscopy, energy dispersive spectroscopy, x-ray diffraction spectroscopy, and x-ray photoelectron spectroscopy were also completed.

Once the sulfur tolerant anode materials were identified, two and three-layer PSOFC anodes were constructed and tested by using EIS and material analyses before and after the tests. In order to optimize the sulfur tolerant multi-layer anode, fractional factorial parametric studies were used to produce an optimized PSOFC anode. The tests took into account the sulfur tolerant powder surface area (m²/g), sulfur tolerant layer thickness, and sintering temperature.

These three parameters were used to optimally design the sulfur tolerant layer of the anode with a pore structure and thickness that allows H₂S to be oxidized before reaching the H₂ oxidation layer.

Many PSOFC button cells were constructed, each having a single layer anode made of different material of interest. The cell was next supplied with a simulated coal syngas mixture based on a gasified Pittsburgh #8 coal. The H₂S concentration of the syngas was varied and the effect of H₂S concentration on the performance of the PSOFC was measured. EIS was used to determine the overpotential, ohmic resistance, and charge transfer resistance of the anode material over time. Materials analyses were completed before and after each trial to determine the effect of the simulated coal syngas on the composition and structure of the anode materials.

Test results were obtained by operating a Nextech (NexTech Materials, Ltd.) NextCell brand advanced electrolyte supported planar cell with a 50/50 wt % lanthanum strontium vanadate/yttria stabilized zirconia (YSZ) protective layer added to the conventional anode. A conventional Nextcell brand cell anode, which contained the Ni, gadolinium doped cerium oxide and YSZ anode with no protective layer, was tested for comparison.

The test had an initial OCV (open cell potential) of the fuel cell of 1.48V compared to a theoretical OCV of 1.52V showing little leakage around the cell. It is known in the technology that OCV is a measure of the Gibb's Free Energy between the reactants (fuel and air) of the system.

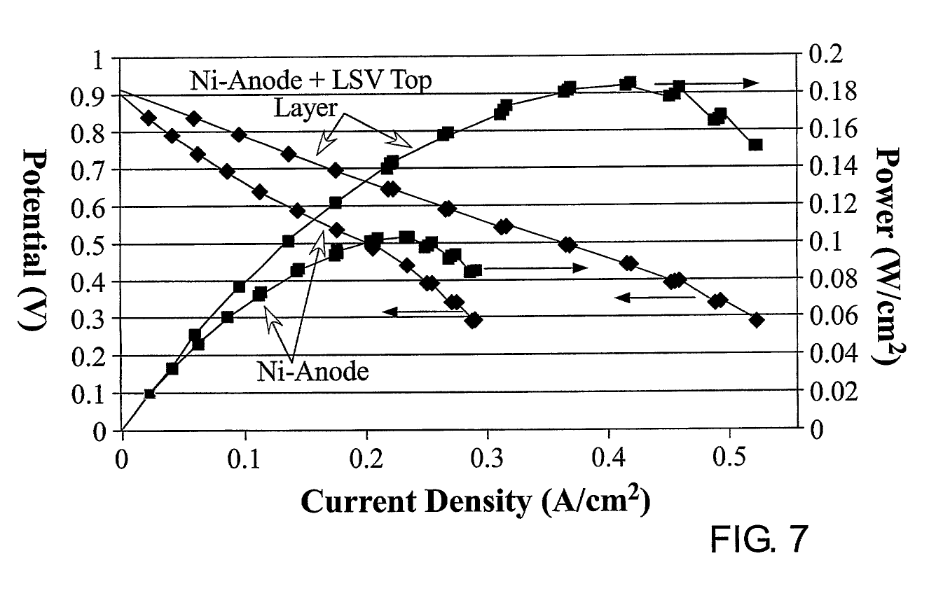

Additionally, in order to determine the performance curve, the fuel cell was operated from 1.1 to 0.3V over 0.05V increments and several (10-20) current measurements are taken at each voltage. FIG. 7 summarizes the results in a VI (voltage-current) scan and power plot. The arrows in the plot pointing to the right refer to the power axis (W/cm2). Thus, the more curved power lines refer to the right vertical axis of the plot. The arrows pointing to the left refer to the potential (voltage) axis. Thus, the more linear lines refer to the VI curves of the fuel cells tested. The x-axis is applicable to both curves.

The data in FIG. 7 referred to as “Ni-Anode” represents the data for a typical Ni-anode, and the data referred to as “Ni-Anode+LSV Top Layer” represents data from the same Ni-anode with the LSV top layer added according to the invention. The plot shows that after 6 hrs of operation with a simulated coal syngas containing 160 ppm H₂S, the cell with the LSV top layer (the invention) had improved PSOFC performance over the conventional cell.

The LSV Top Layer showed an approximate maximum power density gain of 80% compared to the typical Ni-GDC-YSZ anode. This means that adding the LSV Top Layer allowed the same cell to produce 80% more power with a coal syngas containing 160 ppm H₂S. FIG. 7 illustrates the improvement caused by the addition of the LSV top layer to a conventional PSOFC while using a simulated coal syngas with 160 ppm H₂S. The plot shows that the addition of the LSV layer improved the performance of the cell dramatically. The addition of the LSV layer caused the same fuel cell to produce 80% more power under the same testing conditions with the contaminant H₂S.

While certain preferred embodiments of the present invention have been disclosed in detail, it is to be understood that various modifications may be adopted without departing from the spirit of the invention or scope of the following claims.

1. An improved anode in a solid oxide fuel cell having an electrolyte, the anode positioned in a fluid flow path through which a fluid that contains molecular hydrogen and at least one sulfur-containing compound can flow, the anode comprising:
(a) a first anode layer having an outer surface in the fluid flow path, the first anode layer being made of a first material having a diffusion rate for molecular hydrogen that exceeds a diffusion rate for sulfur-containing compounds, the first anode layer material also having an oxidation rate for sulfur-containing compounds that exceeds an oxidation rate for molecular hydrogen; and
(b) a second anode layer interposed between the first anode layer and the electrolyte, the second anode layer made of a material that oxidizes molecular hydrogen.

2. The anode in accordance with claim 1, further comprising at least one other layer interposed between the fluid flow path and the electrolyte.

3. The anode in accordance with claim 1, wherein the first anode layer is selected from the group consisting of Lanthanum Strontium Titinate and Lanthanum Strontium Vanadate.

4. The anode in accordance with claim 3, wherein the second anode layer is made of Gadalonium Doped Cerium oxide and nickel.

5. The anode in accordance with claim 4, wherein the first layer includes Yttria Stabilized Zirconia.

6. The anode in accordance with claim 5, wherein the Yttria Stabilized Zirconia is within the range of about 10 to about 25 weight percent.

7. The anode in accordance with claim 4, wherein the second layer further comprises Yttria Stabilized Zirconia interspersed throughout the layer as a separate phase.

8. The anode in accordance with claim 4, wherein Yttria Stabilized Zirconia is in the range of about 10 to about 25 weight percent.

9. The anode in accordance with claim 7, wherein the second layer further comprises Lanthanum Strontium Vanadate powder interspersed in the second layer at an electrolyte/anode interface.

10. The anode in accordance with claim 9, wherein the powder constitutes about 3.0 weight percent of the second layer.

11. The anode in accordance with claim 10, wherein the first anode layer is between about 5 microns and about 30 microns thick.

12. The anode in accordance with claim 11, wherein a porosity of the first anode layer is less than about forty percent.

13. An improved anode in a solid oxide fuel cell having an electrolyte, the anode positioned in a fluid flow path through which a fluid that contains molecular hydrogen and at least one sulfur-containing compound can flow, the anode comprising:
(a) a first anode layer having an outer surface in the fluid flow path, the first anode layer being made of a first material selected from the group consisting of Lanthanum Strontium Titinate and Lanthanum Strontium Vanadate; and
(b) a second anode layer interposed between the first anode layer and the electrolyte, the second anode layer made of Gadalonium Doped Cerium oxide and nickel.

14. The anode in accordance with claim 13, wherein the first layer includes Yttria Stabilized Zirconia.

15. The anode in accordance with claim 13, wherein the second layer further comprises Yttria Stabilized Zirconia interspersed throughout the layer as a separate phase.

16. The anode in accordance with claim 15, wherein the second layer further comprises Lanthanum Strontium Vanadate powder interspersed in the second layer at an electrolyte/anode interface.

17. The anode in accordance with claim 16, wherein the powder constitutes about 3.0 weight percent of the second layer.

18. The anode in accordance with claim 17, wherein the first anode layer is between about 5 microns and about 30 microns thick.

19. The anode in accordance with claim 18, wherein a porosity of the first anode layer is less than about forty percent.
